(19) United States
(12) Patent Application Publication
(10) Pub. No.: US 2026/0054671 A1
(43) Pub. Date: Feb. 26, 2026

(54) CLIP ASSEMBLY WITH REVERSIBLE ATTACHMENT MODULE

(71) Applicant: GM GLOBAL TECHNOLOGY OPERATIONS LLC, Detroit, MI (US)

(72) Inventors: Choonghee Rhew, Bupyeong-gu (KR); Seungha Oh, Bucheon-si (KR); Honggi Kim, Goyang-si (KR)

(73) Assignee: GM GLOBAL TECHNOLOGY OPERATIONS LLC, Detroit, MI (US)

(21) Appl. No.: 18/809,534

(22) Filed: Aug. 20, 2024

(51) Int. Cl. B60R 16/08; B60K 15/01; B60T 11/10; F16L 3/02; F16L 3/10

(52) U.S. Cl. CPC B60R 16/08; F16L 3/02; F16L 3/10; B60K 15/01; B60T 11/10

(57) ABSTRACT

A clip assembly includes a frame having a conduit attachment portion having at least one conduit retainer, a module attachment portion having at least one module retainer, and a frame attachment portion configured to attach the frame to a body. The clip assembly also includes an attachment module removably attachable to the module attachment portion between a first orientation and a second orientation. The attachment module includes a base portion having a guide configured to be removably attached to the module attachment portion on the frame in either the first orientation or the second orientation. The attachment module also includes a retainer portion pivotably connected to the base portion and moveable between an open position and a closed position. The base portion and the retainer portion at least partially define a first conduit retention passage and a second conduit retention passage when in the closed position.

### BACKGROUND

The present disclosure related to a clip assembly for fluid conduits.

Vehicles include fluid conduits that transport fluid throughout the vehicle to connect various components. For example, hydraulic brake lines may travel from a front of a vehicle to a rear of the vehicle to connect with brake calipers to apply a braking force to slow the vehicle.

Additionally, a fuel tank in a rear of the vehicle may have a fuel feed line that provides fuel to an internal combustion engine in a front of the vehicle and receives vapor from a vapor return line. These lines or conduits can be secured to a portion of the vehicle with a clip assembly.

### SUMMARY

Disclosed herein is a clip assembly. The clip assembly includes a frame having a conduit attachment portion having at least one conduit retainer, a module attachment portion having at least one module retainer, and a frame attachment portion configured to attach the frame to a body. The clip assembly also includes an attachment module removably attachable to the module attachment portion between a first orientation and a second orientation opposite the first orientation. The attachment module includes a base portion having a guide configured to be removably attached to the module attachment portion on the frame in either the first orientation or the second orientation. The attachment module also includes a retainer portion pivotably connected to the base portion and moveable between an open position and a closed position fixed relative to the base portion. The base portion and the retainer portion at least partially define a first conduit retention passage and a second conduit retention passage when in the closed position.

In one aspect of the disclosure the first conduit retention passage includes a first diameter and the second conduit retention passage includes a second diameter different from the first diameter.

In one aspect of the disclosure the retainer portion defines a recess that is configured to accept a portion of the frame attachment portion when the attachment module is in first orientation and the retainer portion is in the open position.

In one aspect of the disclosure the recess extends into the first conduit retention passage.

In one aspect of the disclosure one of the base portion or the retainer portion includes a hook and the other of the base portion or the retainer portion includes a retainer for securing the retainer portion in the closed position relative to the base portion.

In one aspect of the disclosure the at least one conduit retainer on the conduit attachment portion includes at least one brake line retainer.

In one aspect of the disclosure the at least one brake line retainer includes a pair of flexible detents.

In one aspect of the disclosure the at least one conduit retainer on the conduit attachment portion includes a pair of brake line retainers.

In one aspect of the disclosure the attachment module includes one of a hook or a groove for engaging the other of the hook or the groove on the module attachment portion.

In one aspect of the disclosure the module attachment portion defines a rail configured to slidably accept one of the hook or the groove within the guide on the base portion of the attachment module.

In one aspect of the disclosure the rail includes a trapezoidal cross section.

In one aspect of the disclosure the conduit attachment portion on the frame is separated from the module attachment portion by the frame attachment portion.

Disclosed herein is a method of utilizing a clip assembly. The method includes determining a desired orientation of a frame relative to an attachment module and attaching the attachment module to the frame in the desired orientation to form the clip assembly. The frame includes a module attachment portion having a rail that is accepted within a groove of a base portion of the attachment module when forming the clip assembly. The method also includes securing the clip assembly relative to a vehicle body with the frame including a frame attachment portion configured to engage the vehicle body. The method also includes securing conduits to the clip assembly. The frame includes at least one conduit retainer for securing a corresponding conduit and attachment module includes a first conduit retention passage configured to accept a first conduit and a second conduit retention passage configured to accept a second conduit when a retainer pivotably attached to the base portion is moved from an open position to a closed position.

In one aspect of the disclosure the first conduit retention passage includes a first diameter and the second conduit retention passage includes a second diameter different from the first diameter.

In one aspect of the disclosure the method includes positioning a brake line in the at least one conduit retainer.

In one aspect of the disclosure the first conduit is a vapor return line and the second conduit is a fuel line.

Disclosed herein is a vehicle system. The clip assembly includes a vehicle body supported by wheels and fluid conduits fixed relative to the vehicle body with a clip assembly. The clip assembly includes a frame having a conduit attachment portion having at least one conduit retainer, a module attachment portion having at least one module retainer, and a frame attachment portion configured to attach the frame to a body. The clip assembly also includes an attachment module removably attachable to the module attachment portion between a first orientation and a second orientation opposite the first orientation. The attachment module includes a base portion having a guide configured to be removably attached to the module attachment portion on the frame in either the first orientation or the second orientation. The attachment module also includes a retainer portion pivotably connected to the base portion and moveable between an open position and a closed position fixed relative to the base portion. The base portion and the retainer portion at least partially define a first conduit retention passage and a second conduit retention passage when in the closed position.

### BRIEF DESCRIPTION OF DRAWINGS

FIG. 1 is a schematic illustration of a vehicle having a clip assembly.

FIG. 2 is a schematic illustration of the clip assembly of FIG. 1 having an attachment module and a frame.

FIG. 3 is schematic illustration of a bottom perspective view of the attachment module of FIG. 2.

FIG. 4 is a schematic illustration of the attachment module attached to frame in the first orientation with the attachment module in an open position.

FIG. 5 is a schematic illustration of the attachment module attached to frame in the first orientation with the attachment module in a closed position.

FIG. 6 is a schematic illustration of the clip assembly having the attachment module attached to frame in the second orientation with the attachment module in the open position.

FIG. 7 is a flow diagram of an example method utilizing the clip assembly of FIG. 1 with conduits.

Some embodiments of the present disclosure are now described, by way of example only, and with reference to the accompanying drawings. The same reference number represents the same element or the same type of element on all drawings.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

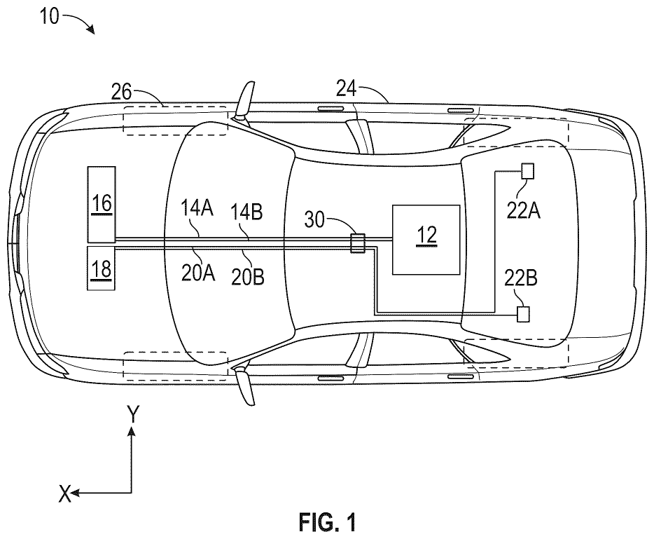

Referring to the FIGS., wherein like numerals indicate like parts referring to the drawings, wherein like reference numbers refer to like components, FIG. 1 is a schematic plan diagram illustrating a context of a system is shown. The system may implement a vehicle 10.

The vehicle 10 generally comprises a vehicle body 24, such as a passenger compartment, which is supported by a plurality wheels 26. An internal combustion engine 16 receives fuel from a fuel tank 12 through a fuel line 14A. Fuel vapors can turn to the fuel tank 12 from the internal combustion engine 16 through a vapor return line 14B. Alternatively, the vapor return line 14B can come from another source, such as an evaporative emissions system (not shown).

A brake system 18, such as a brake booster and/or fluid distribution module, can direct pressurized hydraulic brake fluid through a first brake line 20A to a first brake caliper 22A and through a second brake line 20B to a second brake caliper 22B. A clip assembly 30 is secured to the vehicle body 24 to support the first and second brake lines 20A and 20B in addition to the fuel line 14A and vapor return line 14B. Due to variations in vehicle design, the fuel line 14A and vapor return line 14B may be in different lateral locations when passing through the clip assembly 30. Because the fuel line 14A and the vapor return line 14B can have different diameters, this requires that the clip assembly 30 be able to accommodate lines or conduits of different diameters.

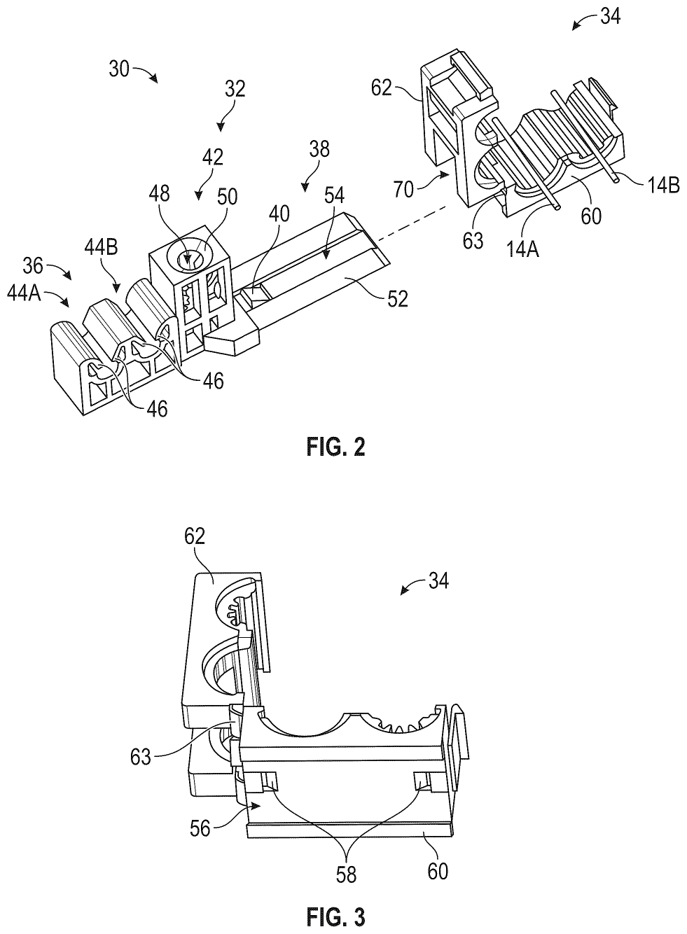

As shown in FIG. 2, the clip assembly 30 includes a frame 32 and an attachment module 34. The attachment module 34 can be attached to the frame 32 in a first orientation (FIGS. 2-4) or a second orientation (FIGS. 5-7). One feature of positioning the attachment module 34 in either the first or second orientations is that the clip assembly 30 can provide conduit attachment that would normally require two separately designed clips.

As shown in FIGS. 2-4, the frame 32 includes a conduit attachment portion 36 having at least one conduit retainer, a module attachment portion 38 having a module retainer 40, and a frame attachment portion 42 configured to attach the frame 32 relative to the vehicle body 24. In the illustrated example, the conduit attachment portion 36 includes a first brake line retainer 44A and a second brake line retainer 44B. Each of the brake line retainers 44A and 44B include a pair of flexible detents 46 that deform when a conduit is pushed therefore and expand to retain the conduit when located in a seated position.

In the illustrated example, the frame attachment portion 42 is located is located between and separates the conduit attachment portion 36 from the module attachment portion 38. The frame attachment portion 42 includes a receptacle 48 having a retainer 50 that surrounds a perimeter of the receptacle 48 and is configured to accept a mounting projection fixed relative to the vehicle body 24.

In the illustrated example, the module attachment portion 38 defines a rail 52 having a trapezoidal cross-sectional area with a channel 54 extending longitudinally through a central portion of it and at least partially defined by the rail 52. The module retainer 40 is located adjacent to a proximal end of the rail 52 and is aligned with the channel 54. The module retainer 40 includes a hook located adjacent to an end of a projection configured to secure the attachment module 34 to the frame 32 as described in greater detail below.

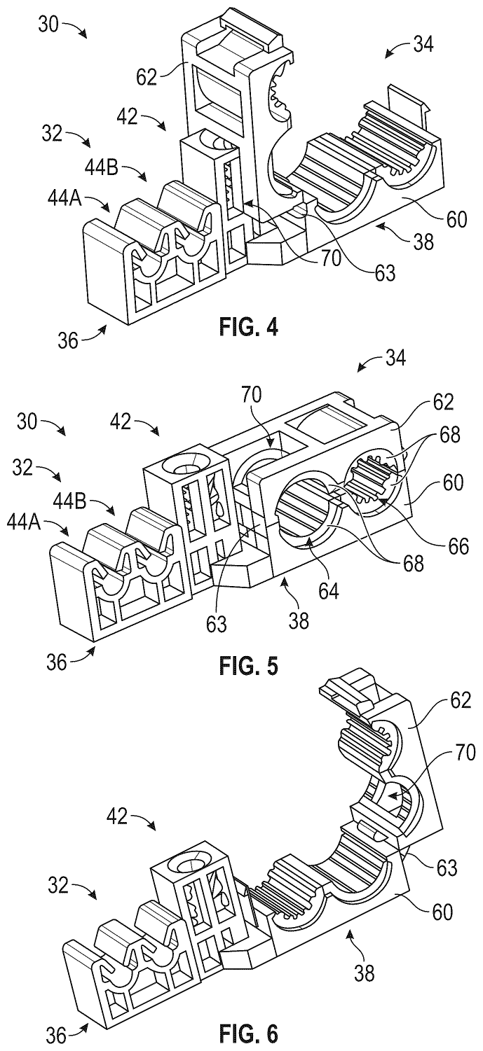

As shown in FIG. 3, the attachment module 34 includes a base portion 60 pivotably attached to a retainer portion 62 by a hinge 63. The base portion 60 includes a guide 56 or recess that extends longitudinally along a bottom portion of the between opposing ends and includes a trapezoidal cross-sectional area. Grooves 58 are located adjacent to the guide 56 and spaced inward from the opposing ends of the attachment module 34. Having the groove 58 located at opposite ends of the attachment module 34 allows the attachment module to be secured to the frame 32 in both the first orientation (FIG. 4) or the second orientation (FIG. 6). The grooves 58 are defined by a body portion of the attachment module 34 and are configured to accept the module retainer 40 on the frame 32. In particular, the groove 58 is configured to accept the hook on the module retainer 40. Additionally, while the illustrated example shows the groove 58 located in the attachment module 34 and the module retainer 40 located on the frame 32, the groove 58 could be in the frame 32 and the module retainer 40 could be located on the attachment module 34.

The retainer portion 62 is pivotable between an open position (FIGS. 4 and 6) and a closed position (FIG. 5) fixed relative to the base portion 60. When in the closed position, the base portion 60 and the retainer portion 62 at least partially define a first conduit retention passage 64 and a second conduit retention passage 66. Additionally, the first and second conduit retention passages 64 and 66 can each include polymer inserts 68 configured to directly engage an exterior surface of a conduit passing therethrough. Furthermore, the polymer inserts 68 can provide vibration damping between the conduits and the vehicle body 24. In the illustrated example, the first conduit retention passage 64 includes a first diameter and the second conduit retention passage 66 includes a second diameter that is different from the first diameter.

As shown in FIG. 4, when the attachment module 34 is in the first orientation, a recess 70 defined at least partially by the retainer portion 62 is configured to accept the frame attachment portion 42 when in the open position. This allows greater access when placing conduits in the attachment module while still maintaining a compact design for the clip assembly 30. In the illustrated example, the recess 70 extends into the first conduit retention passage 64.

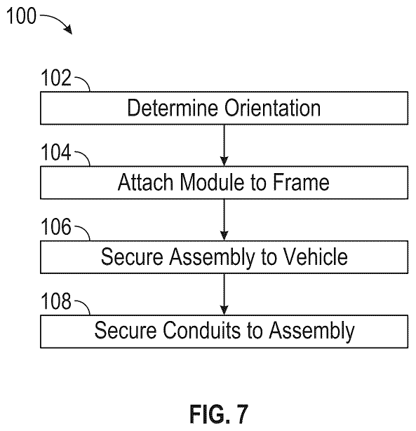

FIG. 7 is a flow diagram of an example method 100 utilizing the clip assembly 30. The method 100 begins at block 102 (“Determine Orientation”), with determining a desired orientation of the attachment module 34 relative to the frame 32. As described above, the attachment module 34 can be attached to the frame 32 in either the first orientation (FIG. 4) or the second orientation (FIG. 6) depending on the orientation of the conduits that will pass through the first and second retention passages 64 and 66. Once the orientation has been determined, the method 100 proceeds to block 104.

At block 104 (“Attach Module to Frame”), the attachment module 34 is attached to the frame 32 in either the first or the second orientation as determined from block 102. The attachment module 34 is attached to the frame 32 by sliding the rail 52 on the frame 32 into the guide 56 until the retainer 40 engages one of the grooves 58 on the attachment module 34 to form the clip assembly 30. The method then proceeds to block 106.

At block 106 (“Secure Assembly to Vehicle”), the clip assembly 30 with the frame 32 and the attachment module 34 are secured relative to the vehicle body 24. The clip assembly is secured by utilizing the frame attachment portion 42 on the frame 32 to engage a projection on the vehicle body 24. The method 100 then proceeds to Block 108.

At block 108 (“Secure Conduits to Assembly”), the brake lines 20A or 20B or lines 14A or 14B are attached to the clip assembly 30. The brake lines 20A and 20B are attached to the corresponding first or second brake line retainers 44A or 44B by passing the brake lines 20A and 20B past the detents 46. The lines 14A and 14B are attached to the corresponding first or second conduit retention passages 64 or 66 in the attachment module 34 by enclosing them with the retainer portion 62 as the retainer portion 62 is moved from the open position to the closed position.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A clip assembly comprising:
a frame including:
a conduit attachment portion having at least one conduit retainer;
a module attachment portion having at least one module retainer; and
a frame attachment portion configured to attach the frame to a body; and
an attachment module removably attachable to the module attachment portion between a first orientation and a second orientation opposite the first orientation, wherein the attachment module includes:
a base portion including a guide configured to be removably attached to the module attachment portion on the frame in either the first orientation or the second orientation; and
a retainer portion pivotably connected to the base portion and moveable between an open position and a closed position fixed relative to the base portion, wherein the base portion and the retainer portion at least partially define a first conduit retention passage and a second conduit retention passage when in the closed position.

2. The clip assembly of claim 1, wherein the first conduit retention passage includes a first diameter and the second conduit retention passage includes a second diameter different from the first diameter.

3. The clip assembly of claim 1, wherein the retainer portion defines a recess that is configured to accept a portion of the frame attachment portion when the attachment module is in first orientation and the retainer portion is in the open position.

4. The clip assembly of claim 3, wherein the recess extends into the first conduit retention passage.

5. The clip assembly of claim 1, wherein one of the base portion or the retainer portion includes a hook and the other of the base portion or the retainer portion includes a retainer for securing the retainer portion in the closed position relative to the base portion.

6. The clip assembly of claim 1, wherein the at least one conduit retainer on the conduit attachment portion includes at least one brake line retainer.

7. The clip assembly of claim 6, wherein the at least one brake line retainer includes a pair of flexible detents.

8. The clip assembly of claim 7, wherein the at least one conduit retainer on the conduit attachment portion includes a pair of brake line retainers.

9. The clip assembly of claim 1, wherein the attachment module includes one of a hook or a groove for engaging the other of the hook or the groove on the module attachment portion.

10. The clip assembly of claim 9, wherein the module attachment portion defines a rail configured to slidably accept one of the hook or the groove within the guide on the base portion of the attachment module.

11. The clip assembly of claim 10, wherein the rail includes a trapezoidal cross section.

12. The clip assembly of claim 1, wherein the conduit attachment portion on the frame is separated from the module attachment portion by the frame attachment portion.

13. A method of utilizing a clip assembly, the method comprising:
determining a desired orientation of a frame relative to an attachment module;
attaching the attachment module to the frame in the desired orientation to form the clip assembly, wherein the frame includes a module attachment portion having a rail that is accepted within a groove of a base portion of the attachment module when forming the clip assembly;
securing the clip assembly relative to a vehicle body, wherein the frame includes a frame attachment portion configured to engage the vehicle body; and
securing conduits to the clip assembly, wherein the frame includes at least one conduit retainer for securing a corresponding conduit and attachment module includes a first conduit retention passage configured to accept a first conduit and a second conduit retention passage configured to accept a second conduit when a retainer pivotably attached to the base portion is moved from an open position to a closed position.

14. The method of claim 13, wherein the first conduit retention passage includes a first diameter and the second conduit retention passage includes a second diameter different from the first diameter.

15. The method of claim 14, including positioning a brake line in the at least one conduit retainer.

16. The method of claim 13, wherein the first conduit is a vapor return line and the second conduit is a fuel line.

17. A vehicle system comprising:
a vehicle body supported by a plurality of wheels;
a plurality of fluid conduits fixed relative to the vehicle body with a clip assembly,
wherein the clip assembly includes:
a frame including:
a conduit attachment portion having at least one conduit retainer;
a module attachment portion having at least one module retainer; and
a frame attachment portion configured to attach the frame to a body; and
an attachment module removably attachable to the module attachment portion between a first orientation and a second orientation opposite the first orientation, wherein the attachment module includes:
a base portion including a guide configured to be removably attached to the module attachment portion on the frame in either the first orientation or the second orientation; and
a retainer portion pivotably connected to the base portion and moveable between an open position and a closed position fixed relative to the base portion, wherein the base portion and the retainer portion at least partially define a first conduit retention passage and a second conduit retention passage when in the closed position.

18. The vehicle system of claim 17, wherein the retainer portion defines a recess that is configured to accept a portion of the frame attachment portion when the attachment module is in first orientation and the retainer portion is in the open position and the recess extends into the first conduit retention passage.

19. The vehicle system of claim 17, wherein the attachment module includes one of a hook or a groove for engaging the other of the hook or the groove on the module attachment portion.

20. The vehicle system of claim 17, including a brake line located in the at least one conduit retainer, a vapor return line in the first conduit retention passage, and a fuel line in the second conduit retention passage.
